(19) United States
(12) Patent Application Publication
(10) Pub. No.: US 2011/0276500 A1
(43) Pub. Date: Nov. 10, 2011

(54) Processing a request for an IP right

(75) Inventor: Thomas Haines, Western Australia (AU)

(73) Assignee: FGH IP PTY LTD, East Perth, Western Australia (AU)

(21) Appl. No.: 13/062,084

(22) PCT Filed: Sep. 3, 2009
(86) PCT No.: PCT/AU2009/001147

§ 371 Date: May 5, 2011

(30) Foreign Application Priority Data
Sep. 3, 2008 (AU) 2008904580
Dec. 10, 2008 (AU) 2008906369

(51) Int. Cl. G06Q 50/00

(52) U.S. Cl. 705/310

(57) ABSTRACT

A system and process for filing a request with an administrative body, the system having a communications interface and a server connectable to a data communications network. A primary module of the server is able to receive data about an IP right from a user. This data is then used by a data gateway to access information on the IP right. A verification module verifies the ability to validly file the request based on the information accessed by the data gateway. The primary module is operatively coupled to a communications module. The communications module is able to send a message via the communications interface to file the request with the administrative body. The communications module is also able to receive electronic acknowledgement via the communications interface in response to the message sent. The primary module is able to issue a notification to the user confirming the filing of the request.

### FIELD OF THE INVENTION

The present invention relates to a process, system and server for filing a national patent application.

A reference herein to “IP” means “intellectual property”.

A reference herein to “IP” includes each type of IP that may be applied for, by at least one applicant, to an administrative body. By way of example only, three types of such IP include patents, trade marks and designs.

A reference herein to an “IP right” includes a reference to an application for an IP right (“IP application”) and, or alternatively, to an IP right that has been granted, issued, registered or otherwise bestowed (“IP grant”).

A reference herein to an “international IP right” includes a reference to an IP right that has the effect of designating one or more countries, groups of countries or regions from which at least one selection may be made of the countries, groups of countries or regions in which to file a national IP application based on the international IP right. It includes, by way of example only, an international application filed under the provisions of the Patent Cooperation Treaty (PCT), a European patent application, filed under the provisions of the European Patent Convention, a Eurasian patent application, a patent application filed in OAPI and a patent application filed in ARIPO,

A reference herein to a “national IP right” includes a reference to an IP right that has the effect of an IP right in a country, group of countries or region. A national IP right may be a “national IP application” or a “national IP grant”. It includes, by way of example only, a European patent application, filed under the provisions of the European Patent Convention, a Eurasian patent application, a patent application filed in OAPI, a patent application filed in ARIPO, as well as a patent application filed in an individual country, and patents that may be granted on, or from, such applications.

A reference herein to an “administrative body” includes a reference to a server of an administrative body and any agent or facility, or server of any agent or facility, able to receive requests for, or on behalf of, an administrative body,

Throughout this specification, unless the context requires otherwise, the word “comprise” or variations such as “comprises” or “comprising”, and the word “include” or variations such as “includes” or “including”, will be understood to imply the inclusion of a stated integer or group of integers but not the exclusion of any other integer or group of integers.

The headings in this specification, including the headings in the description and claims, are provided to assist the reader, and are not to be interpreted so as to narrow or limit the scope of the disclosure in the description, claims, abstract or drawings.

### BACKGROUND OF THE INVENTION

With the shift in recent years to the handling of many transactions electronically, systems have been devised to electronically file various transactions with administrative bodies. The administrative body, for example, may be a national or regional IP office. The transactions that may be filed with such IP offices include the filing of IP applications and requests in relation to IP rights.

A service provider may make available an electronic filing system to a customer or client, i.e. a user, so that the user can electronically engage the service provider to electronically file the transaction with the relevant IP office. In implementing such a system, one consideration is the ease of use of the electronic filing system for the user. Another consideration is that the desired transaction is being performed on the desired IP right. A further consideration is that the user is able to complete the transaction using the electronic filing system at any time that is convenient for the user.

Addressing the first consideration may involve implementing the electronic filing system so that it is user-friendly, requires only minimal data inputs from the user and allows the user to complete the transaction in a short period of time.

One way to address the second consideration, i.e. that the desired transaction is being performed on the desired IP right, is by ensuring that the electronic filing system has access to an authoritative data store of IP rights at all times. This permits the details of the IP right, in relation to which the transaction is being filed, to be checked and confirmed at the time that the transaction is being performed by the user. As the name implies, the authoritative data store is a data store having a high degree of accuracy and reliability in relation to the details of the IP rights that are stored in the authoritative data store. Typically, the authoritative data store is a database maintained by a national or regional IP office of organisation.

Addressing the third consideration, i.e. that the user is able to complete the transaction at any time that is convenient for the user, requires that the electronic filing system is available to the user at all times and is fully operational at all times.

Whilst the first consideration can be successfully addressed by incorporating appropriate design features into the electronic filing system, the other two are more problematic. Since it cannot be predicted when a user may choose to use the electronic filing system to complete a transaction, the electronic filing system must be available at all times. Since the electronic filing system requires access to the authoritative data store at the time that the transaction is being performed, the authoritative data store must also be available at all times. However, the authoritative data store may not be available at all times. For example, the authoritative data store may experience periodic downtimes for maintenance or there may be technical problems with the authoritative data store that result in the authoritative data store being periodically unavailable. During such periodic downtimes and technical problems experienced by the authoritative data store, the electronic filing system is unable to access the authoritative data store. This means that the electronic filing system is unable to check and confirm details of the IP right, for the intended transaction, in the authoritative data store. Consequently, the electronic filing system is unavailable to the user when the authoritative data store is experiencing downtime or technical problems. From the perspective of the service provider and also the user, this is disadvantageous since it limits the ability of the user to use the electronic filing system.

### SUMMARY OF THE INVENTION

In accordance with one aspect of the present invention there is provided a system for filing a request with an administrative body comprising a communications interface to send communications to an administrative body, a server connectable to a data communications network, the server including a primary module to receive at least some data pertaining to at least one IP right that uniquely identifies the at least one IP right, a data gateway module, operatively coupled to the primary module, to access at least one data store containing information pertaining to a plurality of IP rights, in response to a data query from the primary module containing at least some of the data received by the primary module, the at least one data store comprising an authoritative data store and a local data store cache, an application download module operatively coupled to the data gateway module to download information pertaining to the at least one IP right from the authoritative data store, an availability determination module, operatively coupled to the data gateway module, to determine the availability of the authoritative data store by assessing whether the application download module has downloaded the information pertaining to the at least one IP right from the authoritative data store within a specified interval, and then indicating the availability of the authoritative data store based on that assessment, a verification module operatively coupled to the primary module to verify the ability to file the request based on at least some of the information contained in the at least one data store accessed by the data gateway module, a communications module operatively coupled to the primary module to send a message, containing data identifying the at least one IP right, via the communications interface to file the request with the administrative body, the communications module adapted to receive electronic acknowledgement via the communications interface in response to the message sent, and the primary module adapted to issue a notification pertaining to the filing of the request after receipt of the electronic acknowledgement, wherein the data gateway module is adapted to access information pertaining to the at least one IP right contained in the authoritative data store if the authoritative data store is available, and if the availability determination module determines that the authoritative data store is not available, the data gateway module adapted to access information pertaining to the at least one IP right contained in the local data store cache, and wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right and miscellaneous correspondence in relation to an IP right.

Preferably, wherein the verification module adapted to verify the ability to file the request based on at least some of the information accessed by the data gateway module by verifying in accordance with criteria relevant to the purpose of the request that the request can be validly filed, wherein at least one criterion is selected from the group comprising: a) whether the request has previously not been filed with the administrative body; b) whether the request has previously not been actioned by the administrative body; and c) whether the request complies with regulatory requirements as required by the administrative body.

Preferably, wherein the server further comprises an acknowledgement processing module operatively coupled to the primary module to process the electronic acknowledgement and wherein the electronic acknowledgement includes a unique identifier and the primary module is adapted to include the unique identifier in the notification it issues pertaining to the filing of the request.

Preferably, wherein the communications module is arranged to send the message, containing data identifying the at least one IP right via the communications interface to file the request with the administrative body, as a facsimile transmission message comprising at least one document file.

More preferably, the communications module adapted to send the facsimile transmission message, comprising at least one document file, to a third party with a direction to the third party to on-send the at least one document file by facsimile transmission to the administrative body, and

the communications module adapted to receive the electronic acknowledgement, in response to the facsimile transmission message sent to the third party, as confirmation of the transmission of the at least one document file to the administrative body.

Preferably, the primary module is adapted to include explanatory text in the notification based on the least some data pertaining to the at least one IP right.

In accordance with another aspect of the present invention there is provided a process for filing a request with an administrative body comprising receiving at least some data pertaining to at least one IP right that uniquely identifies the at least one IP right, accessing at least one data store, containing information pertaining to a plurality of IP rights, using at least some of the data received pertaining to the at least one IP right, the at least one data store comprising an authoritative data store and a local data store cache, retrieving information pertaining to the at least one IP right from the data store, verifying the ability to file the request based on at least some of the information retrieved from the data store, sending a message to file the request with the administrative body, receiving electronic acknowledgement in response to the message sent, and issuing a notification pertaining to the filing of the request with the administrative body, wherein accessing at least one data store, containing information pertaining to a plurality of IP rights, using at least some of the data received pertaining to the at least one IP right comprises accessing the authoritative data store using at least some of the data received pertaining to the at least one IP right, and determining the availability of an authoritative data store containing information pertaining to a plurality of IP rights by assessing whether the information pertaining to the at least one IP right has been received from the authoritative data store within a specified interval, accessing a local data store cache, containing information pertaining to a plurality of IP rights, using at least some of the data received pertaining to the at least one IP right if access to the authoritative data store is determined to be not available, and wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right, and miscellaneous correspondence in relation to an IP right.

Preferably, verifying the ability to file the request based on at least some of the information retrieved from the data store comprises verifying in accordance with criteria relevant to the purpose of the request that the request can be validly filed, wherein at least one criterion is selected from the group comprising: a) whether the request has previously not been filed with the administrative body; b) whether the request has previously not been actioned by the administrative body; and c) whether the request complies with regulatory requirements as required by the administrative body.

Preferably, receiving electronic acknowledgement in response to the message sent comprises receiving electronic acknowledgement that includes a unique identifier, and issuing a notification pertaining to the filing of the request with the administrative body comprises issuing a notification that includes the unique identifier.

Preferably, sending a message to file the request with the administrative body comprises sending a facsimile transmission message, comprising at least one document file, to file the request with the administrative body.

More preferably, sending a facsimile transmission message, comprising at least one document file, to file the request with the administrative body comprises sending the facsimile transmission message to a third party and directing the third party to on-send the at least one document file by facsimile transmission to the administrative body, and wherein receiving electronic acknowledgement in response to the facsimile transmission message sent to the third party comprises receiving confirmation of the transmission of the at least one document file to the administrative body.

Preferably, issuing a issuing a notification pertaining to the filing of the request with the administrative body comprises issuing a notification containing explanatory text based on the at least some data pertaining to the at least one IP right.

Preferably, the process further comprises providing at least some of the information retrieved from the data store to a user and requesting the user to confirm that the at least some information provided to the user pertains to the at least one IP right, and receiving confirmation from a user that the at least some information provided to the user pertains to the at least one IP right.

In accordance with yet another aspect of the present invention there is provided a server connectable to a data communications network for use in filing a request with an administrative body comprising a primary module to receive at least some data pertaining to at least one IP right that uniquely identifies the at least one IP right, a data gateway module, operatively coupled to the primary module, to access at least one data store containing information pertaining to a plurality of IP rights, in response to a data query from the primary module containing at least some of the data received by the primary module, the at least one data store comprising an authoritative data store and a local data store cache, an availability determination module, operatively coupled to the data gateway module, to determine the availability of the authoritative data store by assessing whether the application download module has downloaded the information pertaining to the at least one IP right from the authoritative data store within a specified interval, and then indicating the availability of the authoritative data store based on that assessment, a verification module operatively coupled to the primary module to verify the ability to file the request based on at least some of the information contained in the at least one data store accessed by the data gateway module, a communications module operatively coupled to the primary module to send a message, containing data identifying the at least one IP right, via the communications interface to file the request with the administrative body, the communications module adapted to receive electronic acknowledgement via the communications interface in response to the message sent, and the primary module adapted to issue a notification pertaining to the filing of the request after receipt of the electronic acknowledgement, wherein the data gateway module is adapted to access information pertaining to the at least one IP right contained in the authoritative data store if the authoritative data store is available, and if the availability determination module determines that the authoritative data store is not available, the data gateway module adapted to access information pertaining to the at least one IP right contained in the local data store cache, and wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right and miscellaneous correspondence in relation to an IP right.

Preferably, the verification module adapted to verify the ability to file the request based on at least some of the information accessed by the data gateway module by verifying in accordance with criteria relevant to the purpose of the request that the request can be validly filed, wherein at least one criterion is selected from the group comprising: a) whether the request has previously not been filed with the administrative body; b) whether the request has previously not been actioned by the administrative body; and c) whether the request complies with regulatory requirements as required by the administrative body.

Preferably, the server further comprises an acknowledgement processing module operatively coupled to the primary module to process the electronic acknowledgement and wherein the electronic acknowledgement includes a unique identifier and the primary module is adapted to include the unique identifier in the notification it issues pertaining to the filing of the request.

Preferably, the communications module is arranged to send the message, containing data identifying the at least one IP right via the communications interface to file the request with the administrative body, as a facsimile transmission message comprising at least one document file.

More preferably, the communications module adapted to send the facsimile transmission message, comprising at least one document file, to a third party with a direction to the third party to on-send the at least one document file by facsimile transmission to the administrative body, and the communications module adapted to receive the electronic acknowledgement, in response to the facsimile transmission message sent to the third party, as confirmation of the transmission of the at least one document file to the administrative body.

Preferably, the primary module is adapted to include explanatory text in the notification based on the least some data pertaining to the at least one IP right.

### BRIEF DESCRIPTION OF THE DRAWINGS

The present invention will now be described, by way of example only, with reference to the accompanying drawings, in which:

FIG. 1 is a schematic diagram illustrating an embodiment of a system in accordance with another aspect of the present invention that incorporates an embodiment of a server in accordance with a further aspect of the present invention.

FIG. 2 is a flow chart illustrating an embodiment of the process for filing a patent application in accordance with an aspect of the present invention; and

### DETAILED DESCRIPTION

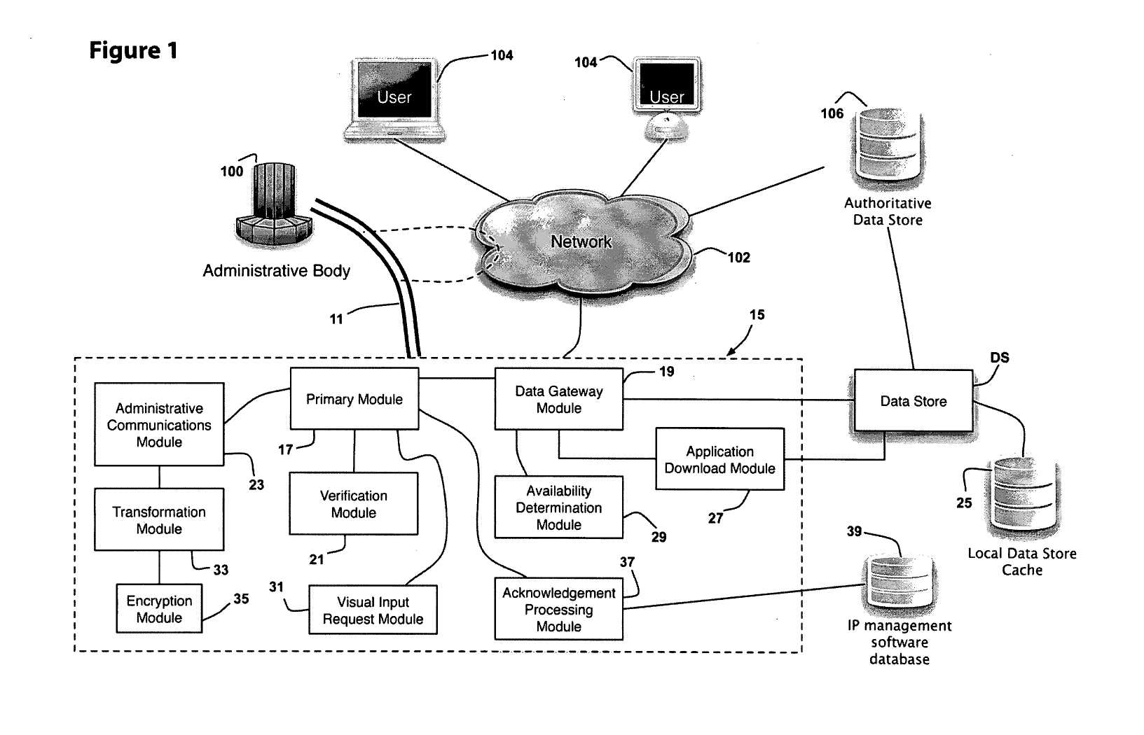

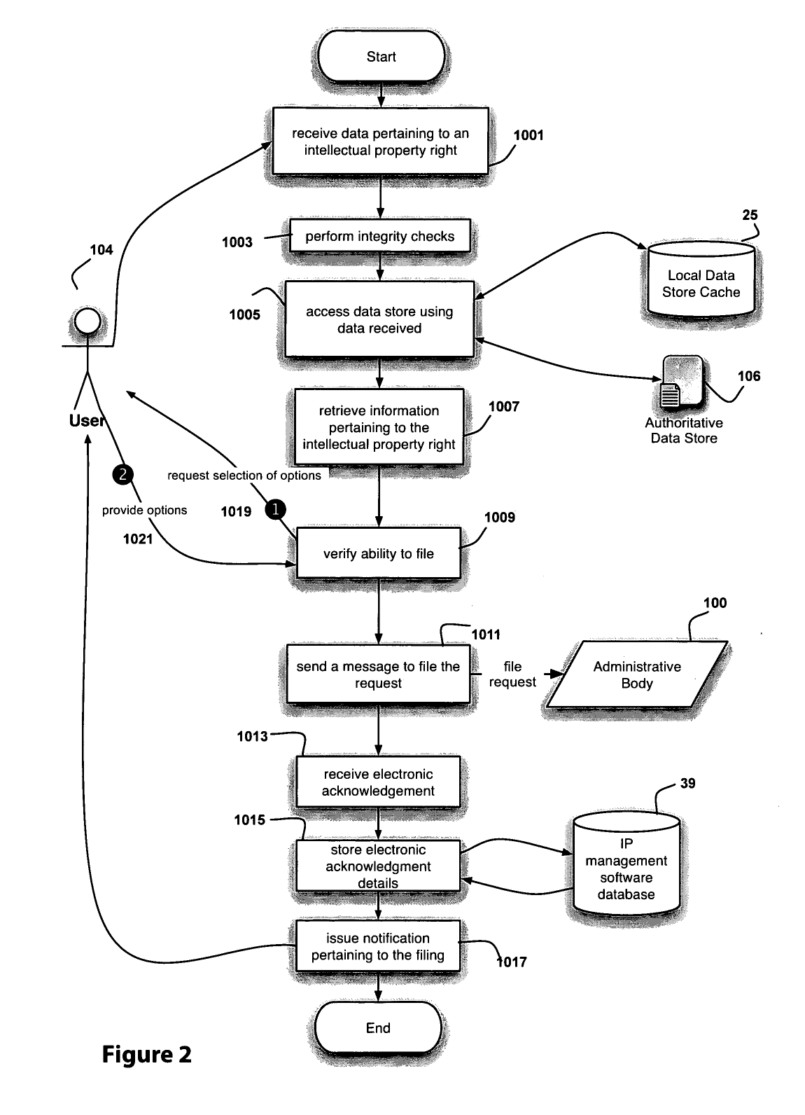

An embodiment of the present invention will now be described with reference to FIGS. 1 and 2 of the drawings.

In these figures, there is shown a system 10 for filing a request with an administrative body 100.

In the present embodiment, the administrative body 100 is a national or regional IP office capable of receiving the request to be filed, or an agent acting for a national or regional IP office capable of receiving the request to be filed (hereinafter referred to as an “IP office”).

The system 10 comprises a communications interface 11 and a server 15. The communications interface 11 enables the server 15 to access the administrative body 100 such that the request to be filed with the administrative body 100 is sent via the communications interface 11. The server 15 is connectable to a data communications network 102 via the communications interface 11.

The server 15 comprises modules to facilitate the filing of the request with the administrative body 100.

The server 15 comprises a primary module 17 to receive at least some data pertaining to at least one IP right (hereinafter referred to as the “IP right”) from a user 104 and a data gateway module 19 that is operatively coupled to the primary module 17. The data gateway module 19 is able to access information pertaining to the IP right in response to a data query from the primary module containing at least some of the data received by the primary module 17 from the user 104.

The server also comprises a verification module 21 that is operatively coupled to the primary module 17. The verification module 21 is able to verify the ability to file the request based on at least some of the information accessed by the data gateway module 19.

The server 15 additionally comprises a communications module 23 that is operatively coupled to the primary module 17. The communications module 23 is able to send a message via the communications interface 11. The message sent by the communications module 23 contains data that identifies the IP right. Sending of the message by the communications module 23 results in, or causes, the filing of the request with the administrative body 100.

The communications module 23 is able to receive electronic acknowledgement in response to the message sent. The electronic acknowledgment is received via the communications interface 11. The primary module 17 is also able to issue a notification pertaining to the filing of the request after the electronic acknowledgment is received by the communications module.

The communications module 23 is able to send, the message to file the request, as an electronic message or as a facsimile transmission message, as will be later herein described in more detail.

In the case that the communications module 23 sends the message as an electronic message, the method of communication utilised is the TCP/IP protocol, and the protocol is used over the data communications network 102, which preferably is in the form of the Internet 17.

In the case that the communications module 23 sends the message as a facsimile transmission message, the method of communication may utilise a modem to access the communications network 102 which may be a traditional copper-based telephony network .

A user interface is provided to interface the server 15 with a user 104 via a web browser interface. The request/response cycle of a web browser interface is understood by a person skilled in the art.

In the present embodiment, the server 15 runs on CentOS <centos.org>, which is a linux variant.

Alternatively, any other suitable operating system containing a communications stack may be utilised. To facilitate the web application interface, the Apache Tomcat <tomcat.apache.org> web server may be used. There are many alternative web server solutions, such as, for example, Sun™ Glassfish, Microsoft™ ASP or PHP.

In addition to receiving at least some data pertaining to the IP right from the user 104, the primary module 17 is also able to receive data from the user 104 that identifies the user 104 including contact and address details of the user 104.

The purpose of the request to be filed with the administrative body 100 may be, for example, an application for an IP right (including a national patent application based on an international IP right), a request for examination of an IP right, payment of a grant, registration or issue fee for an IP right, renewal of an IP right, request for amendment of an IP right, any other request or notice that may be filed in relation to an IP right and miscellaneous correspondence in relation to an IP right.

### Data Input

The at least some data pertaining to the IP right that the primary module 17 is able to receive from the user 104 (hereinafter referred to as “IP right input data”) should include data that uniquely identifies the IP right (hereinafter referred to as “IP right identifier data”).

Preferably, the IP right identifier data is in the form of an application number or a publication number, as it is a common practice of IP offices worldwide to allocate unique a application number and or publication number to all IP rights they administer. However, the IP right identifier data received by the primary module may alternatively contain data other than the application and/or publication number, provided that it can uniquely identify the IP right. Furthermore, the IP right identifier data may include information additional to the application number or publication number if such additional information is required by the administrative body 100, to uniquely identify the IP right. Examples of additional information that may be required by some IP offices to uniquely identify the IP right include the type of IP right (such as patent, trade mark or design) and/or the country in which the IP right was filed.

Further, the IP right input data that the primary module 17 is able to receive from the user 104 may include data that identifies the purpose of the request. This may be in the form of a series of buttons identifying each request type allowing the user 104 to select the type of request by pressing the appropriate button.

Furthermore, the IP right input data that the primary module 17 is able to receive from the user 104 may include at least one document file. The document file, for example, may be in PDF format or RTF format.

To receive the IP right input data, the primary module 17 needs an input method to receive the data from the user 104. In the present embodiment, the primary module 17 presents a dialog, via a web page, to the user 104 at 1001, which acts as a prompt, or request, asking the user 104 to input the IP right input data. The user 104 then responds to this dialog prompt by submitting an input in the form of the IP right input data. An alternative for the primary module 17 to receive data that identifies the purpose of the request is to present a web page to the user 104 with options from which the user 104 is able to make a selection of the purpose of the request. The primary module 17 receives the IP right input data input and/or selected by the user 104.

If the IP right input data includes at least one document file, the user 104 may input the document file by uploading it via the web page and the primary module 17 will also receive it, at 1001.

The primary module 17 then performs some initial integrity checks at 1003, by checking that the IP right identifier data provided by the user 104 conforms to the format and content for the IP right identifier data required by the administrative body 100.

By way of example, if the IP right is an international (PCT) patent application and the purpose of the request, to be filed with the administrative body 100, is to enter the national phase, i.e. filing a national phase patent application, the IP right identifier data may be either the international application number or the international publication number of the IP right. The international application number takes the format PCT/CCYYYY/NNNNNN and the international publication number takes the format WO/YYYY/NNNNNN where CC=country code, YYYY is the year, and NNNNNN is an identifying number. In this case, the integrity checks performed by the primary module 17 check that the IP right identifier data input by the user 104 conforms to either the international application number format or the international publication number format, or variants that are acceptable to the administrative body 100.

As the formats for IP right identifier data may change from time to time, the integrity checks by the primary module 17 should also be adapted, to reflect the IP right identifier data schemas in place.

If the initial integrity checks of the IP right identifier data input by the user 104 are satisfied, the primary module 17 sends a data query to a data gateway module 19 of the server 15. In this embodiment, the data query sent includes the IP right identifier data.

### Access Data Store

The data gateway module 19 uses the data query received from the primary module 17 to access at least one data store DS at 1005. The data store DS contains information pertaining to a plurality of IP rights. The data store DS includes information pertaining to the IP right.

The data store DS contains various information pertaining to each IP right contained in the data store DS. For example, information contained in the data store DS for each IP right may include basic data relating to each IP right, information about actions that have occurred on the IP right and actions that are to occur in the future.

Examples of basic data relating to each IP right include the application number, publication number, grant/registration/issue number, applicant and/or owner, inventor and/or designer priority date, filing date, publication date, renewal status, title, abstract and scope of cover. By way of example, scope of cover may include the broadest claim when the IP type is a patent, the goods/services and international class when the IP type is a trade mark and a drawings figure when the IP type is a design. In the case of an international IP right, the basic data may also include identification of the language of the international IP right as filed and the language of the IP right as published. For example, in the case of an international patent application filed under the provisions of the PCT, this includes the language of the patent specification.

Examples of actions that have occurred on the IP right and actions that are to occur in the future include filing a request for examination, payment of a grant, registration or issue fee, payment of a renewal fee (sometimes referred to as an annuity, continuation or maintenance fee), amendments, filing an application for another IP right based on the IP right, and any other action that may be taken in relation to the IP right. In the case of an international IP right, the basic data may also include identification of actions taken on the IP right under the provisions of the treaty giving rise to the international IP right. For example, in the case of an international patent application filed under the provisions of the PCT, this includes whether Chapter 2 of the PCT is applicable to that international patent application.

The information contained in the data store DS about actions that have occurred on the IP right and actions that are to occur in the future may be stored, for example, as “YES” flags or dates in cases where the actions have occurred, and “NO” flags or dates in cases where the actions are due to occur in the future.

The data store DS may comprise a local data store cache 25. The local data store cache 25 may be in the form of a MySQL Server. However, there are many alternative database systems that may be utilised, including products developed by Oracle™, Sybase™ or Microsoft™ SQL Server.

The MySQL database used includes indexed information pertaining to a plurality of IP rights.

The data store DS may also comprise an authoritative data store 106. An authoritative data store 106 contains information pertaining to a plurality of IP rights. The authoritative data store 106 may be maintained by an administrative body.

Depending upon the administrative body that administers the IP right, or the purpose of the request to be filed, the authoritative data store 106 may be one that is maintained by the administrative body 100, with which the request is to be filed, or one that is maintained by another administrative body.

For example, if the IP right is one that is administered by the administrative body 100, the administrative data store 106 is one that is maintained by the administrative body 100. In such circumstances, the request may be a request in relation to the IP right. Examples of such requests include application for the IP right, a request for examination of the IP right, payment of a grant, registration or issue fee for the IP right, renewal of the IP right, request for amendment of the IP right, any other request or notice that may be filed in relation to the IP right and miscellaneous correspondence in relation to the IP right.

On the otherhand, if the IP right is one that is administered by an administrative body other than the administrative body 100, then the administrative data store 106 is one that is maintained by that other administrative body. In such circumstances, the request may be a request in relation to a national IP right based on an international IP right and the IP right is that international IP right. Examples of such requests include an a national or regional phase entry patent application based on an international patent application.

The server 15 further comprises an application download module 27 to download information pertaining to the IP right from the authoritative data store 106. The application download module 27 is operatively coupled to the data gateway module 19.

The method of downloading information varies according to the authoritative data store 106. The application download module 27 needs to be able to download information about the IP right based on the IP right input data pertaining to that IP right.

In this embodiment, the application download module 27 queries the authoritative data store 106 by sending the IP right identifier data to the authoritative data store 106. In response, the authoritative data store 106 returns information pertaining to the IP right in the form of a web page. The application download module 27 then parses the HTML content constituting the web page, to extract the information.

There are many techniques for parsing HTML content as would be appreciated by a person skilled in the art. In the present embodiment, the application download module 27 uses the Java Swing HTML Parser—javax.swing.text.html.parser—package provided by Sun Microsystems™ <http://java.sun.com/j2se/1.4.2/docs/>. The Java Swing HTML Parser converts the HTML returned by the administrative data store 106 into a series of objects representing the HTML. It will be understood by a person skilled in the art that there are many other data mining libraries that could be used in the same manner.

The application download module 27 iterates over the series of objects to extract the information pertaining to the IP right. The application download module 27 then stores this information in the local data store cache 25.

The application download module 27 may also be used to periodically update the information contained in the local data store cache 25 pertaining to the plurality of IP rights contained in the authoritative data store 106, as would be understood by a person skilled in the art.

The data gateway module 19 has two options available to it when accessing the data store DS. It may access either the local data store cache 25 or the authoritative data store 106. It is always preferable to access the authoritative data store 106. However, the authoritative data store 106 may be subject to intermittent downtime, due to maintenance or network connectivity issues.

The most typical downtime issue is network connectivity. However, in the case of a lack of network connection, the networking stack of a typical computer takes some time to detect the lack of connectivity in the form of a timeout, which can take up to 60 seconds, depending on the configuration of the networking stack. From the viewpoint of providing a fluent user experience to the user 104, this is an unacceptable delay. For example, the user 104 may think that the lookup has failed, and subsequently exit the web page interface by closing the web browser window. Whilst the local data cache 25 is likely to be available with greater consistency, the authoritative data store 106 is the preferred source.

From a systems design viewpoint, a decision must be made as to which data store DS to use. Accordingly, the server 15 further comprises an availability determination module 29 to determine the availability of the authoritative data store 106 for access by the data gateway module 19. The availability determination module 29 may be in the form of a concurrent thread acting as a timer. More information concerning timers and threads is available in the Sun™ Java™ documentation, and does not itself form a part of the present invention.

The data gateway module 19 may simultaneously access the authoritative data store 106 and the local data store cache 25 with its data query. As the local data store cache 25 is provided locally, there is no additional delay introduced in querying the local data store cache 25.

In order for the availability determination module 29 to determine the availability of the authoritative data store 106, the availability determination module 29 runs a thread that polls the application download module 27 at specified intervals. The availability determination module 29 polls the application download module 29 at a suitable interval. For example, an interval of 500 ms may be used.

Each time the availability determination module 29 polls the application download module 27, it assesses whether it has finished its downloading procedure. If, after a specified interval, the availability determination module 29 determines that the application download module 27 has not successfully downloaded the information from the authoritative data store 106, it signals to the data gateway module 19 that the authoritative data store 106 is not available. In the present embodiment, the specified interval for assessing whether the application download module 29 has successfully downloaded the information from the administrative data store 106 is 4 seconds.

In the event that the authoritative data store 106 is not available, the data gateway module 19 accesses the local data store cache 25 to retrieve information pertaining to the IP right. In the event that the authoritative data store 106 is available, the data gateway module 19 accesses the authoritative data store 106 to retrieve the information pertaining to the IP right. This is shown at 1007. The data gateway module 19 may retrieve all of the information that the local data store cache 25 or the authoritative data store 106, whichever is accessed, has pertaining to the IP right.

In the event that the authoritative data store 106 is not available, the accuracy of the information retrieved from the local data store cache 25 by the data gateway module 19 will typically have a correlation with the frequency with which the local data store cache 25 is updated.

### Visual Input

For the data gateway module 19 to be able to access the authoritative data store 106, it may be a requirement of the administrative body that maintains the authoritative data store 106, that visual indicia is first received by that administrative body. The administrative body specifies the visual indicia it requires and then allows access after it receives the visual indicia it specified. The visual indicia may be in the form of a set of randomly generated alphanumeric characters displayed as an image to a user. The administrative body may specify different visual indicia for each access that is made to the administrative body.

To access the authoritative data store 106 in such circumstances, the server 15 further comprises a visual input request module 31 operatively coupled to the primary module 17. In circumstances when input of visual indicia is required, the initial attempt of the data gateway module 19 to access the authoritative data store 106 is unsuccessful. The data gateway module 19 then signals the primary module 17 that input of visual indicia is required to access the authoritative data store 106. The data gateway module 19 also sends to the primary module 17 the visual indicia specified by the administrative body that is required to access the authoritative data store 106 for that request. The primary module 17 sends the visual indicia to the visual input request module 27. The visual input request module 31 presents a dialog, via a web page, to the user 104, indentifying the visual indicia to the user 104. The dialog acts as a prompt, or request, asking the user 104 to input the visual indicia. The user 104 inputs the visual indicia which is then passed directly to the administrative body. Since the administrative body has received the visual indicia requested, as input by the user 104, the data gateway module 19 is now able to access the authoritative data store 106.

The data gateway module 19 also provides the primary module 17 with the information pertaining to the IP right that it retrieved from the data store DS (i.e. the local data store cache 25 or the authoritative data store 106, as the case may be), at 1007.

The information that the data gateway module 19 retrieves from the data store DS comprises information that is required for the verification module 21 to perform the verification check (as will be further described later herein) and information required to file the request with the administrative body 100.

### Confirmation of Request Data

The primary module 17 may provide at least some of the information pertaining to the IP right, that it received from the data gateway module 19, to the user 104. The primary module 19 simultaneously requests that confirmation is provided that the at least some information pertaining to the IP right that it provided to the user 104 does pertain to the IP right that the user 104 intended. If the primary module 17 receives confirmation that the at least some information pertaining to the IP right provided to the user 104 does pertain to the IP right that the user intended, the process continues. This confirmation step provides the user 104 with an opportunity to check and confirm that the IP right input data that the user input does pertain to the correct IP right that the user intended. The information pertaining to the IP right that the primary module 17 provides to the user 104 in the confirmation step may include IP right identifier data (such as the application, publication, grant/registration/issue number), applicant or owner of the IP right, priority date, filing date and/or title of the IP right.

If the primary module 17 does not receive confirmation that the at least some information pertaining to the IP right provided to the user 104 does pertain to the IP right, the primary module 17 issues an alert message to the user 104, e.g. the primary module invites the user 104 to re-enter the IP right input data and/or notifies the user 104 that the request cannot proceed based on the IP right input data provided by the user 104.

The confirmation process previously described herein may be performed by the primary module 17 presenting a dialog, via a web page, to the user 104, requesting the confirmation. If the confirmation step described herein is included in the process of the present invention and is successfully performed, the primary module 17 passes information to the verification module 21, which carries out the verification check as will be now be described.

### Verification

After the primary module 17 has received the information pertaining to the IP right from the data gateway module 19, it passes that information to the verification module 21 of the server 15. The verification module 21 verifies, at 1009 the ability to file the request based on at least some of the information pertaining to the IP right that it received from the primary module 19.

The verification module 21 performs the verification check, according to one or more criteria, that the request can be filed. The criteria used for the verification are criteria that are relevant to the purpose of the request. Relevant criteria may include verifying that the request has not previously been filed with the administrative body 100, verifying that the request has previously not been actioned by the administrative body 100, and verifying that the request complies with regulatory requirements as required by the administrative body 100.

The information pertaining to the IP right that the data gateway module 19 retrieved from the data store DS, and which the primary module 17 passes on to the verification module 21, may include all available information pertaining to the IP right in the data store DS. This includes the basic data relating to the IP right and information about actions that have occurred on the IP right and actions that are to occur in the future.

The verification module 21 performs the verification check for a request by checking the relevant information pertaining to the IP right, that it received from the primary module 17, against the criteria that are relevant to the purpose of the request.

For example, if the request to be filed is a request for examination of the IP right, the request may need to comply with regulatory requirements, e.g. the request must be filed within a specific period and the IP right must be in force. In addition, the request for examination cannot be validly filed if it has previously been filed. Thus, relevant criteria include whether there is a due date by which a request for examination of the IP right must be filed, whether a renewal fee, if required, has been paid, and also whether a request for examination has previously been filed with the administrative body. The verification module 21 checks the information pertaining to the IP right it received form the primary module 17 to check, for example, if the relevant data fields in that information show that the IP right is still in the allowable period for filing the request for examination, that there is no outstanding renewal fee, and that no request for examination has previously been filed. If the information pertaining to the IP right that the verification module 21 received from the primary module 17 shows that the IP right is still in the allowable period for filing the request for examination, that there is no outstanding renewal and that no request for examination has previously been filed with, or actioned by, the administrative body 100, e.g. no date entered against the request for examination field or the request for examination field shows a “NO” flag, this signifies a positive result which means that the request for examination can be validly filed.

By way of another example, if the request to be filed is payment of a renewal fee for the IP right, the request may need to comply with regulatory requirements, e.g. the request must be filed within a specific period. In addition, the request to pay the renewal fee cannot be validly filed if it has previously been filed. Thus, relevant criteria include whether there is a due date by which the request to pay the renewal fee must be filed and whether a request to pay the renewal fee has previously been filed with the administrative body. The verification module 21 checks the information pertaining to the IP right it received form the primary module 17 to check, for example, if the relevant data fields in that information show that the IP right is still in the allowable period for filing the request to pay the renewal fee and that the renewal fee has not previously been paid. If the information pertaining to the IP right that the verification module 21 received from the primary module 17 shows that the IP right is still in the allowable period for filing the request to pay the renewal fee and that no request to pay the renewal fee has previously been filed with, or actioned by, the administrative body 100, e.g. the current “renewed to” date is for a period less than the next renewal term, this signifies a positive result which means that the request to pay the renewal fee can be validly filed.

By way of a further example, if the request to be filed is a request to enter the national phase of an international patent application, the IP right is the international (PCT) patent application, and the request will need to comply with regulatory requirements. In addition, it is normally desirable to not enter the national phase on an international patent application that has already entered the national phase. Thus, in this case, relevant criteria include the due date (e.g. 30 or 31 months form the earliest priority date of the international patent application) by which the request to enter the national phase must be filed with the administrative body. In addition, other relevant criteria may include that the request is in respect of a national phase entry for a country that was designated in the international patent application and that the patent specification of the international patent application was published in the English language by the International Bureau. For example, if the request for national phase entry is in Australia (in which case the administrative body is the Australian Patent Office), it is a regulatory requirement that Australia was designated in the international patent application. Similarly, if the request for national phase entry is to enter the national phase in Australia, it is a regulatory requirement that, a verified English translation of the patent specification is filed to enter the national phase in Australia. The verification module 21 checks the information pertaining to the international patent application it received form the primary module 17 to check, for example, if the relevant data fields in that information show that the international patent application is still in the relevant period to file to the request for national phase entry (e.g. 30 or 31 months from the earliest priority date). Other criteria include that the country for which the request to enter the national phase is to be filed was designated in the international patent application, that the national phase has not previously been entered in the country, that an applicant exists for the country, and that the patent specification of the international patent application was published in English by the International Bureau. If the information pertaining to the international patent application that the verification module 21 received from the primary module 17 shows that the international patent application is still in the allowable period to file the request for national phase entry, that the country for which the request to enter the national phase is to be filed was actually designated in the international patent application and, if required by the administrative body 100, that the patent specification of the international patent application was published in English by the International Bureau, this signifies a positive result which means that the request to enter the national phase can be validly filed. 105

In the present embodiment, the verification module 21 executes a series of “if-then” statements to determine whether the request can be validly filed based on the criteria relevant to the purpose of the request.

The verification module 21 signals the primary module 17 with the result of the verification check it performed. If the result of the verification check is positive, i.e. that the relevant criteria were met, the primary module 17 signals the communications module 23, to send a message to file the request. The communications module 23 sends the message via the communications interface 11, at 1011, to file the request with the administrative body 100. The message sent by the communications module 23 comprises data to identify the IP right that is the subject of the request, e.g. the IP right identifier data. The message sent by the communications module 23 also comprises data to identify the purpose of the request.

If the result of the verification check is positive, the primary module 17 may present the user 104 with a confirmation prompt prior to primary module 17 sending the signal to the communications module 23 to send the message. The confirmation prompt requests confirmation that the request should be filed. After receiving the confirmation response, the primary module 17 then signals the communications module 23 to send the message as hereinbefore described.

If the result of the verification check is negative, i.e. that the request cannot be filed, the primary module 17 generates an alert flag to the user 104, indicating that the request can not proceed.

### Transformation Module

In order to form the message that is sent by the communications module 23, the server 15 further comprises a transformation module 33. The transformation module 33 transforms the information pertaining to the IP right into formatted data. The formatted data is in a form suitable for the communications module 23 to send as a formatted message. The formatted data contains the relevant information required to file the request with the administrative body 100.

e-Filing/Fax Filing

As previously hereinbefore described, the communications module 23 is able to send the message to file the request as an electronic message or as a facsimile transmission message.

In the case that the message is sent as an electronic message, the communications module 23 sends the message to the administrative body 100 to thereby file the request with the administrative body 100.

In the case that the message is sent as a facsimile transmission message, the communications module 23 sends the message to either the administrative body 100, to thereby file the request with the administrative body 100, or alternatively, sends the message to a third party and directs the third party to on-send, or forward, the message to the administrative body 100 to thereby file the request with the administrative body 100. The third party then forwards the message to the administrative body 100.

The filing of a request with the administrative body 100 by sending a facsimile transmission message may be achieved, in accordance with the present invention, either by sending the facsimile transmission message directly to the administrative body 100, or alternatively, by sending the facsimile transmission message to a third party with directions to the third party to on-send, or forward, the facsimile transmission message to the administrative body 100. Each of these alternatives results in the request being filed with the administrative body 100.

Whether to use an electronic message or a facsimile transmission message to file the request with the administrative body 100 will be determined by factors such as whether the administrative body 100 has the facilities to receive filings of requests electronically or by facsimile transmission as well as preferences of the administrative body 100 and the operator of the system of the present invention.

e-Filing: Transformation/Encryption/Sending/e-Acknowledgement

### Transformation

The transformation module 33 forms a electronic message to be sent in the manner to now be described.

In an embodiment in which the communications module 23 is to send an electronic message, the transformation module 33 transforms the information pertaining to the IP right into the XML language to form a formatted electronic message that contains the relevant information required to file the request with the administrative body 100. The transformation module 33 adheres to an XML-schema provided by the administrative body 100 in the transformation it performs on the data to form the formatted electronic message. For example, with respect to the Australian Patent Office communications requirements, the first packet must adhere to the submitPackage( ) schema. The submitPackage( ) schema includes the reference number of the operator of the server that has been allocated by the administrative body 100, a package type indicating the type of data contained in the XML, and the data identifying the IP right.

In some circumstances, the communications module 23 may also include at least one document file with the formatted electronic message it sends, e.g. to comply with regulatory requirements required by the administrative body. To achieve this, the transformation module 33 follows an agreed protocol so that a document file can be included in the formatted electronic message that the communications module 23 sends. The document file, for example, may be in PDF format. As one example, the administrative body 100 may require that a translation of a document accompany the request.

In this embodiment, the transformation module 33 may use the Direct Internet Message Encapsulation (DIME) protocol to include a document with an XML message. A draft version of the RFC for the DIME protocol can be found at <http://xml.coverpages.org/draft-nielsen-dime-02.txt>.Encryption

After the transformation module 33 has formed the formatted electronic message, the formatted electronic message is passed to an encryption module 35, of the server 15. The encryption module 35 encrypts the formatted electronic message. This may be done, for example, using the SHA-1 encryption method. The encryption module 35 may use a public key encryption system.

After the encryption module 35 has encrypted the formatted electronic message, the communications module 23 sends the encrypted electronic message, including any document file to be include with the encrypted electronic message, via the communications interface 11. This may be achieved, for example, using the TCP/IP protocol over the Internet.

e-Acknowledgement from Administrative Body

For example, when the administrative body 100 is IP Australia and their electronic national phase filing system is used, after the communications module 23 has sent the encrypted electronic message, the communications module 23 polls the administrative body 100 by calling the listWaitingPackages( ) method repeatedly until such time as a response is received. Alternatively, if an event driven system is provided by the administrative body 100, this may be utilised for more efficient communications.

Once the response is available, the communications module 23 receives an electronic acknowledgement from the administrative body 100 by calling the retrievePackage( ) function. After the electronic acknowledgement is received, at 1013, the communications module 23 makes a subsequent call to acknowledgePackage( ) to the administrative body 100 to move the state to RETRIEVED.

If no fault is found, the electronic acknowledgement is processed. The electronic acknowledgement may include the date and time the last byte of the package was received by the administrative body 100 and a unique identifier from the administrative body 100 in the form of an allocated reference number for the transaction.

### Fax Filing: Transformation/Sending/e-Acknowledgement

### Transformation

The transformation module 33 forms a facsimile transmission message to be sent in the manner to now be described.

In an embodiment in which the communications module 23 is to send a facsimile transmission message, the transformation module 33 transforms the information pertaining to the IP right into a PDF document in a suitable form that contains the relevant information required to file the request with the administrative body 100. In order to create this PDF document, a template may be developed in the OfficeOffice.org application and opened via its API, and the relevant fields replaced with the data required. There are different templates for different types of requests. That is, a specific template may be used depending upon the purpose of the request. A given template may include a statement of the type of request being made (i.e. the purpose of the request), the particulars of the IP right, and the payment method (if required) for the request. The OfficeOffice.org API provides a facility to save the document as a PDF file. The PDF format ensures that the document will appear to the recipient in a consistent manner.

Alternatively, the PDF document may be generated using its native file format form without the use of an intermediary utility such as OpenOffice.orgi. The native PDF document creation process may contain the same information in this manner of creation.

In certain circumstances, the communications module 23 may also include additional document(s) in the at least one document file, e.g. to comply with regulatory requirements required by the administrative body. To achieve this, the transformation module 33 appends the additional documents to the end of the PDF document, so that the PDF file contains both the relevant information required by the administrative body 100 relating to the request, and the additional document(s). As one example, the administrative body 100 may require that a translation of a document accompany the request.

Sending & e-Acknowledgment

In one embodiment, the PDF document is sent as a facsimile transmission message directly to the administrative body 100 using a fax driver and a modem, as would be understood by a person skilled in the art. The fax driver provides a response to confirm whether the transmission of the facsimile transmission message sent to the administrative body 100 was successful.

In an alternative embodiment, the communications module 23 is able to send the facsimile transmission message, comprising at least one document file, to a third party with a direction to the third party to on-send, or forward, the at least one document file by facsimile transmission to the administrative body 100. This facilitates the third party to send the facsimile transmission to the administrative body 100 and thus file the request. There are numerous third party fax providers that offer this service. For example, there are providers such as Popfax.com, UTBox.net or FaxMate.com.au.

In this manner, the PDF document file is sent to the third party using either a direct API, or via email. When a direct API is used, the PDF file is sent to the third party, together with the facsimile number that the PDF file should be sent to. In turn, the communications module 23 receives an electronic acknowledgement from the third party in the form of a unique identifier confirming that the third party has received the message from the communications module 23. Alternatively, or in addition, the communications module 23 may also receive from the third party a further unique identifier that confirms that the request to send the PDF facsimile transmission identified by the unique identifier has been successfully sent, or alternatively, has failed.

In utilising a third party provider, it advantageously can provide collaborative evidence that the request was filed with the administrative body 100, in the event of an error in the sending of the PDF document.

If the third party provider does not provide a direct API, then the alternative interface provided by the third party may be utilised. For example, the PDF document may be emailed to a designated email address to initiate the sending of the PDF document. In this case, the unique identifier for the transaction is included in the email message to the third party by the communications module 23, and a record made of that unique identifier. The communications module 23 can in turn process a return email from the third party that indicates whether the third party successfully sent the facsimile transmission.

The primary module 17 can then issue the notification pertaining to the filing of the request to thereby confirm the transmission of the at least one document to file the request with the administrative body 100. Alternatively, the notification concerning the filing of the request may be issued by the primary module 17 only in the event that the transmission to file the request with the administrative body 100 was successful. The notification process is further described later herein.

### Processing Acknowledgement

The server 15 further comprises an acknowledgement processing module 37 to process the electronic acknowledgement, previously hereinbefore described, received by the communications module 23. The acknowledgement processing module 37 stores information pertaining to the filing of the request in an IP management software database 39, at 1015. The information pertaining to the filing of the request that is stored in the IP management software database 39 may include the IP right identifier, the unique identifier for the transaction, and the date and time that the message was sent by the communications module 23 to file the request. This may be achieved, for example, using a series of SQL statements to insert the data via a JDBC connector into a database structure such as, for example, the Patrix™ Patricia™ software database. In this respect, the existing infrastructure of an IP management software database 39 may be utilised to track the IP right subsequent to filing the request.

### Notification

The primary module 17 is able to issue a notification pertaining to the filing of the request following receipt of the electronic acknowledgement. The notification is issued to the user 104. The notification provides a record pertaining to the filing of the request to the user 104. Furthermore, the notification provides pertinent information relevant to the IP right.

The notification is issued at 1017, after the acknowledgement processing module 37 has stored the information pertaining to the filing of the request, the unique identifier for the transaction, and the date and time that the message was sent to file the request, into the IP management software database 39, at 1015.

Alternatively, the notification may be issued concurrently. However, for quality assurance purposes, it is preferable that the notification is delayed until it is ascertained that all the information has been safely stored in the IP management software database 39, at 1015.

In the present embodiment, the notification includes the details of the IP right, a unique identifier that was allocated in connection with the transaction and the date and time that the message was sent by the communications module 23 to file the request.

The notification is provided to the user 104 in two forms. Firstly, the information is displayed via the Apache Tomcat web application server to inform the user of the transaction outcome. Secondly, a new thread is created to send the same information to the user 104 via email.

The modules of the server 15 described herein may be located on separate pieces of physical hardware. Alternatively, the modules of the server 15 described herein may be housed on one machine. Control processes, embodied in software, may be utilised to operatively connect these modules into a single cohesive process.

Modifications and variations, such as would be apparent to a skilled addressee are deemed to be within the scope of the present invention.

What is claimed is:

1-209. (canceled)

210. A system for filing a request with an administrative body comprising:
a communications interface to send communications to an administrative body,
a server connectable to a data communications network, the server including:
a primary module to receive at least some data pertaining to at least one IP right that uniquely identifies the at least one IP right,
a data gateway module, operatively coupled to the primary module, to access at least one data store containing information pertaining to a plurality of IP rights, in response to a data query from the primary module containing at least some of the data received by the primary module, the at least one data store comprising an authoritative data store and a local data store cache,
an application download module operatively coupled to the data gateway module to download information pertaining to the at least one IP right from the authoritative data store,
an availability determination module, operatively coupled to the data gateway module, to determine the availability of the authoritative data store by assessing whether the application download module has downloaded the information pertaining to the at least one IP right from the authoritative data store within a specified interval, and then indicating the availability of the authoritative data store based on that assessment,
a verification module operatively coupled to the primary module to verify the ability to file the request based on at least some of the information contained in the at least one data store accessed by the data gateway module,
a communications module operatively coupled to the primary module to send a message, containing data identifying the at least one IP right, via the communications interface to file the request with the administrative body, the communications module adapted to receive electronic acknowledgement via the communications interface in response to the message sent, and
the primary module adapted to issue a notification pertaining to the filing of the request after receipt of the electronic acknowledgement,
wherein the data gateway module is adapted to access information pertaining to the at least one IP right contained in the authoritative data store if the authoritative data store is available,
if the availability determination module determines that the authoritative data store is not available, the data gateway module adapted to access information pertaining to the at least one IP right contained in the local data store cache, and
wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right and miscellaneous correspondence in relation to an IP right.

211. The system according to claim 210, wherein the verification module adapted to verify the ability to file the request based on at least some of the information accessed by the data gateway module by verifying in accordance with criteria relevant to the purpose of the request that the request can be validly filed, wherein at least one criterion is selected from the group comprising:
a) whether the request has previously not been filed with the administrative body;
b) whether the request has previously not been actioned by the administrative body; and
c) whether the request complies with regulatory requirements as required by the administrative body.

212. The system according to claim 210, wherein the server further comprises an acknowledgement processing module operatively coupled to the primary module to process the electronic acknowledgement and wherein the electronic acknowledgement includes a unique identifier and the primary module is adapted to include the unique identifier in the notification it issues pertaining to the filing of the request.

213. The system according to claim 210, wherein the communications module is arranged to send the message, containing data identifying the at least one IP right via the communications interface to file the request with the administrative body, as a facsimile transmission message comprising at least one document file.

214. The system according to claim 213, wherein the communications module adapted to send the facsimile transmission message, comprising at least one document file, to a third party with a direction to the third party to on-send the at least one document file by facsimile transmission to the administrative body, and
the communications module adapted to receive the electronic acknowledgement, in response to the facsimile transmission message sent to the third party, as confirmation of the transmission of the at least one document file to the administrative body.

215. The system according to claim 210, wherein the primary module is adapted to include explanatory text in the notification based on the least some data pertaining to the at least one IP right.

216. A process for filing a request with an administrative body comprising:
receiving at least some data pertaining to at least one IP right that uniquely identifies the at least one IP right,
accessing at least one data store, containing information pertaining to a plurality of IP rights, using at least some of the data received pertaining to the at least one IP right, the at least one data store comprising an authoritative data store and a local data store cache,
retrieving information pertaining to the at least one IP right from the data store,
verifying the ability to file the request based on at least some of the information retrieved from the data store,
sending a message to file the request with the administrative body,
receiving electronic acknowledgement in response to the message sent, and
issuing a notification pertaining to the filing of the request with the administrative body,
wherein accessing at least one data store, containing information pertaining to a plurality of IP rights, using at least some of the data received pertaining to the at least one IP right comprises
accessing the authoritative data store using at least some of the data received pertaining to the at least one IP right, and
determining the availability of an authoritative data store containing information pertaining to a plurality of IP rights by assessing whether the information pertaining to the at least one IP right has been received from the authoritative data store within a specified interval,
accessing a local data store cache, containing information pertaining to a plurality of IP rights, using at least some of the data received pertaining to the at least one IP right if access to the authoritative data store is determined to be not available, and
wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right, and miscellaneous correspondence in relation to an IP right.

217. The process according to claim 216, wherein verifying the ability to file the request based on at least some of the information retrieved from the data store comprises verifying in accordance with criteria relevant to the purpose of the request that the request can be validly filed, wherein at least one criterion is selected from the group comprising:
a) whether the request has previously not been filed with the administrative body;
b) whether the request has previously not been actioned by the administrative body; and
c) whether the request complies with regulatory requirements as required by the administrative body.

218. The process according to claim 216, wherein receiving electronic acknowledgement in response to the message sent comprises receiving electronic acknowledgement that includes a unique identifier, and issuing a notification pertaining to the filing of the request with the administrative body comprises issuing a notification that includes the unique identifier.

219. The process according to claim 216, wherein sending a message to file the request with the administrative body comprises sending a facsimile transmission message, comprising at least one document file, to file the request with the administrative body.

220. The process according to claim 219, wherein sending a facsimile transmission message, comprising at least one document file, to file the request with the administrative body comprises sending the facsimile transmission message to a third party and directing the third party to on-send the at least one document file by facsimile transmission to the administrative body, and wherein receiving electronic acknowledgement in response to the facsimile transmission message sent to the third party comprises receiving confirmation of the transmission of the at least one document file to the administrative body.

221. The process according to claim 216, wherein issuing a issuing a notification pertaining to the filing of the request with the administrative body comprises issuing a notification containing explanatory text based on the at least some data pertaining to the at least one IP right.

222. The process according to claim 216, wherein the process further comprises providing at least some of the information retrieved from the data store to a user and requesting the user to confirm that the at least some information provided to the user pertains to the at least one IP right, and receiving confirmation from a user that the at least some information provided to the user pertains to the at least one IP right.

223. A server connectable to a data communications network for use in filing a request with an administrative body comprising:
a primary module to receive at least some data pertaining to at least one IP right that uniquely identifies the at least one IP right,
a data gateway module, operatively coupled to the primary module, to access at least one data store containing information pertaining to a plurality of IP rights, in response to a data query from the primary module containing at least some of the data received by the primary module, the at least one data store comprising an authoritative data store and a local data store cache,
an availability determination module, operatively coupled to the data gateway module, to determine the availability of the authoritative data store by assessing whether the application download module has downloaded the information pertaining to the at least one IP right from the authoritative data store within a specified interval, and then indicating the availability of the authoritative data store based on that assessment,
a verification module operatively coupled to the primary module to verify the ability to file the request based on at least some of the information contained in the at least one data store accessed by the data gateway module,
a communications module operatively coupled to the primary module to send a message, containing data identifying the at least one IP right, via the communications interface to file the request with the administrative body, the communications module adapted to receive electronic acknowledgement via the communications interface in response to the message sent, and
the primary module adapted to issue a notification pertaining to the filing of the request after receipt of the electronic acknowledgement,
wherein the data gateway module is adapted to access information pertaining to the at least one IP right contained in the authoritative data store if the authoritative data store is available,
wherein if the availability determination module determines that the authoritative data store is not available, the data gateway module adapted to access information pertaining to the at least one IP right contained in the local data store cache, and
wherein the request is a request from the group comprising: an application for an IP right, a request for examination of an IP right, payment of a grant, registration or issue fee for an IP right, renewal of an IP right, request for amendment of an IP right, any other request or notice that may be filed in relation to an IP right and miscellaneous correspondence in relation to an IP right.

224. The server according to claim 223, wherein the verification module adapted to verify the ability to file the request based on at least some of the information accessed by the data gateway module by verifying in accordance with criteria relevant to the purpose of the request that the request can be validly filed, wherein at least one criterion is selected from the group comprising:
a) whether the request has previously not been filed with the administrative body;
b) whether the request has previously not been actioned by the administrative body; and
c) whether the request complies with regulatory requirements as required by the administrative body.

225. The server according to claim 223, wherein the server further comprises an acknowledgement processing module operatively coupled to the primary module to process the electronic acknowledgement and wherein the electronic acknowledgement includes a unique identifier and the primary module is adapted to include the unique identifier in the notification it issues pertaining to the filing of the request.

226. The server according to claim 223, wherein the communications module is arranged to send the message, containing data identifying the at least one IP right via the communications interface to file the request with the administrative body, as a facsimile transmission message comprising at least one document file.

227. The server according to claim 226, wherein the communications module adapted to send the facsimile transmission message, comprising at least one document file, to a third party with a direction to the third party to on-send the at least one document file by facsimile transmission to the administrative body, and
the communications module adapted to receive the electronic acknowledgement, in response to the facsimile transmission message sent to the third party, as confirmation of the transmission of the at least one document file to the administrative body.

228. The server according to claim 223, wherein the primary module is adapted to include explanatory text in the notification based on the least some data pertaining to the at least one IP right.
